(19) United States
(12) Patent Application Publication
(10) Pub. No.: US 2026/0348512 A1
(43) Pub. Date: Nov. 5, 2026

(54) QUICK HITCH SAFETY STAND AND STORAGE APPARATUS

(71) Applicant: Eric Neal Donelson, Shoshoni, WY (US)

(72) Inventor: Eric Neal Donelson, Shoshoni, WY (US)

(21) Appl. No.: 19/194,466

(22) Filed: Apr. 30, 2025

(51) Int. Cl. F16M 11/22; F16M 11/04; F16M 11/42

(52) U.S. Cl. CPC F16M 11/22; F16M 11/041; F16M 11/42

(57) ABSTRACT

A quick hitch safety stand and storage apparatus supports a tractor quick hitch in a stable, upright position to enable safe attachment and detachment. The apparatus includes a base frame, a central vertical support, lower hitch support arms with recessed receiving brackets, and an upper hitch retention bracket. A telescoping system within the vertical support allows for height adjustment, which may be controlled manually by a locking pin or automatically through a hydraulic or pneumatic actuator. In some embodiments, a tie rod air cylinder is mounted using a clevis bracket and pin to permit pivoting during operation. Optional caster assemblies support movement over different surface types. The apparatus aligns hitch connection points at adjustable heights, improving efficiency during attachment or removal without requiring external lifting equipment. It is usable in agricultural, commercial, or industrial settings where quick hitch storage, positioning, or detachment is necessary, including environments involving non-functional tractor hydraulics.

### BACKGROUND OF THE INVENTION

### 1. Field of the Invention

The present invention relates generally to tractor hitching systems and, more specifically, to an improved quick hitch safety stand that enhances the safety, efficiency, and storage of quick hitches used in agricultural, residential, and commercial applications. 2. Description of Related Art

Tractors utilize quick hitches to rapidly connect and disconnect implements, streamlining the process of switching between attachments such as plows, mowers, and tillers. Quick hitches typically attach to a tractor's three-point hitch system, allowing for more efficient use of equipment in farming, construction, and industrial settings. While these systems are designed to improve workflow, they introduce significant safety, storage, and handling challenges for operators.

One of the primary issues with conventional quick hitches is the difficulty and danger associated with mounting and dismounting them from a tractor. Quick hitches can weigh upwards of 75 pounds or more, and their awkward positioning often requires operators to lift, balance, and maneuver the heavy equipment—posing serious risks of personal injury, including back strain, crushed fingers, and foot injuries. Many operators resort to makeshift methods such as leaning the quick hitch against a wall, resting it on unstable surfaces, or even storing it in weeds or remote areas, which not only creates safety hazards but also leads to lost, damaged, or misplaced hitches.

For tractor owners, the frustration of handling quick hitches is a recurring issue, leading to inefficiencies, lost time, and unnecessary financial costs. Farmers, shop technicians, and equipment operators frequently experience difficulty locating their quick hitch, resulting in lost productivity. In some cases, operators purchase a new quick hitch each year due to misplacement or damage. Shops servicing tractors often need to remove quick hitches to access the rear of the tractor, which can require additional labor or equipment such as cranes—further increasing downtime and labor costs.

Additionally, improper storage and handling of quick hitches can cause damage to surrounding equipment and the tractor itself. Instances of bale forks breaking windows, hydraulic hoses being crushed, and vehicles being inadvertently damaged due to the improper handling of quick hitches are common. These risks are amplified in environments where children or bystanders may be present, increasing the likelihood of accidents and injuries.

Given these challenges, there is a critical need for a solution that enhances the safety, convenience, and organization of quick hitch handling. The present invention provides a secure, stable, and accessible storage solution that eliminates the risks associated with improper handling and placement of quick hitches. By introducing a standardized method for securing quick hitches when not in use, the present invention addresses key concerns of safety, efficiency, and equipment longevity for farmers, shop technicians, and tractor operators.

This innovative solution not only enhances safety by reducing the likelihood of personal injury and equipment damage but also optimizes workflow by minimizing time-consuming mounting and dismounting processes. The present invention provides a dedicated storage and handling system that improves shop organization, reduces labor-intensive operations, and ensures that quick hitches are readily available, secure, and easy to use.

Accordingly, the present invention introduces a necessary industry standard that prioritizes safety, efficiency, and cost savings, ultimately revolutionizing the way quick hitches are stored and managed in agricultural, commercial, and industrial applications.

### BRIEF SUMMARY OF THE INVENTION

This summary is provided to introduce a selection of concepts that are further described below in the Detailed Description. This summary is not intended to identify key or essential features of the claimed subject matter, nor is it to be used as an aid in limiting the scope of the claimed subject matter.

Embodiments of the present invention generally relate to a system and apparatus implemented, constructed, and used according to the present invention and designed to enhance the storage, handling, and transportation of quick hitches through the use of a durable, stable, and efficient quick hitch safety stand. The invention provides a stand constructed from high-strength steel, featuring a reinforced base frame for stability, a central vertical support for secure positioning, and an upper hitch retention bracket designed to securely hold quick hitches in an upright position. The compact and ergonomic design allows for improved maneuverability and safe storage in confined areas such as workshops, equipment sheds, and agricultural facilities, making it particularly suitable for farmers, shop technicians, and tractor operators.

Additional embodiments of the present invention generally relate to methods of enhancing quick hitch handling by incorporating mobility and height-adjustment features. The stand may include heavy-duty caster assemblies to facilitate easy transport and repositioning without requiring additional lifting equipment. Pneumatic and hydraulic height-adjustment mechanisms enable controlled raising and lowering of the quick hitch engagement points, allowing seamless alignment for attachment and detachment. Certain embodiments integrate a telescoping system that enhances adaptability across different quick hitch sizes and tractor configurations.

Objects of the invention not understood from the above will be fully understood upon the review of the drawings and the description of the preferred embodiments which follow. Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any aspect of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

A more complete understanding of embodiments of the present invention may be obtained by reference to the following Detailed Description when taken in conjunction with the accompanying Drawings wherein:

FIG. 1 illustrates a side perspective view of the stand, according to an embodiment of the present invention;

FIG. 2 illustrates a side view of the stand, according to an embodiment of the present invention;

FIG. 3 illustrates a back view of the stand, according to an embodiment of the present invention;

FIG. 4 illustrates a front perspective view of the stand, according to an embodiment of the present invention;

FIG. 5 illustrates a top view of the stand, according to an embodiment of the present invention;

FIG. 6 illustrates a side perspective view of a tractor with the stand and quick hitch in position with the tractor, according to an embodiment of the present invention;

FIG. 7 illustrates a side view of a stand with caster assemblies and holding a quick hitch, according to an embodiment of the present invention; and

FIG. 8 illustrates a side view of a stand with a height adjustment mechanism, according to an embodiment of the present invention.

### DETAILED DESCRIPTION OF THE INVENTION

In the following description, numerous specific details are set forth to provide a thorough understanding of the present invention. However, it will be apparent to those skilled in the art that the present disclosure may be practiced without such specific details. It is to be understood that both the foregoing general summary description and the following detailed description are illustrative and explanatory, and are not restrictive of the subject matter, as claimed. It is to be further understood that the following disclosure also provides many different embodiments, or examples, for implementing different features of various illustrative embodiments. Specific examples of components and arrangements are described below to simplify the disclosure. These are, of course, merely examples and are not intended to be limiting. For example, a figure may illustrate an exemplary embodiment with multiple features or combinations of features that are not required in one or more other embodiments and thus a figure may disclose one or more embodiments that have fewer features or a different combination of features than the illustrated embodiment. Embodiments may include some but not all the features illustrated in a figure and some embodiments may combine features illustrated in one figure with features illustrated in another figure. Therefore, combinations of features disclosed in the following detailed description may not be necessary to practice the teachings in the broadest sense and are instead merely to describe particularly representative examples. In addition, the disclosure may repeat reference numerals and/or letters in the various examples. This repetition is for the purpose of simplicity and clarity and does not itself dictate a relationship between the various embodiments and/or configurations discussed.

In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise. In addition, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “inboard,” “outboard,” “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

As used herein, the terms “connect,” “connection,” “connected,” “in connection with,” and “connecting” may be used to mean in direct connection with or in connection with via one or more elements. Similarly, the terms “couple,” “coupling,” and “coupled” may be used to mean directly coupled or coupled via one or more elements. Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include such elements or features.

The term “substantially,” “approximately,” and “about” is defined as largely but not necessarily wholly what is specified (and includes what is specified; e.g., substantially 90 degrees includes 90 degrees and substantially parallel includes parallel), as understood by a person of ordinary skill in the art. The extent to which the description may vary will depend on how great a change can be instituted and still have a person of ordinary skill in the art recognized the modified feature as still having the required characteristics and capabilities of the unmodified feature. In general, but subject to the preceding, a numerical value herein that is modified by a word of approximation such as “substantially,” “approximately,” and “about” may vary from the stated value, for example, by 0.1, 0.5, 1, 2, 3, 4, 5, 10, or 15 percent.

The section headings used herein are for organizational purposes and are not to be construed as limiting the subject matter described. If any documents, or portions of documents, are cited in this application, including, but not limited to, patents, patent applications, articles, books, and treatises, such documents are hereby expressly incorporated herein by reference in their entirety for any purpose. In the event that one or more of such incorporated documents etc. and similar materials (if any) defines a term in a manner that contradicts the definition of that term in this application, this application controls.

The present invention relates to a stand 1 designed to provide a secure, stable, and efficient system for storing, mounting, and dismounting a Category 1-3 quick hitch 5 used in agricultural and industrial applications. The quick hitch 5 itself is used to rapidly connect and disconnect tractor attachments, but storing and handling them safely has long been a challenge. The stand 1 of the present invention eliminates the common risks associated with manual lifting, tipping, and improper storage, reducing injuries, equipment damage, and inefficiencies.

The stand 1 firmly supports the quick hitch in an upright, locked position, preventing tipping and simplifying the attachment/detachment process. When a quick hitch 5 is not in use, it can be securely stored on the stand 1 without risk of falling over. Additionally, certain embodiments as will be described further below incorporate a telescoping an air cylinder 100 for height adjustment, particularly useful in servicing tractors with hydraulic failures.

### Structural Configuration

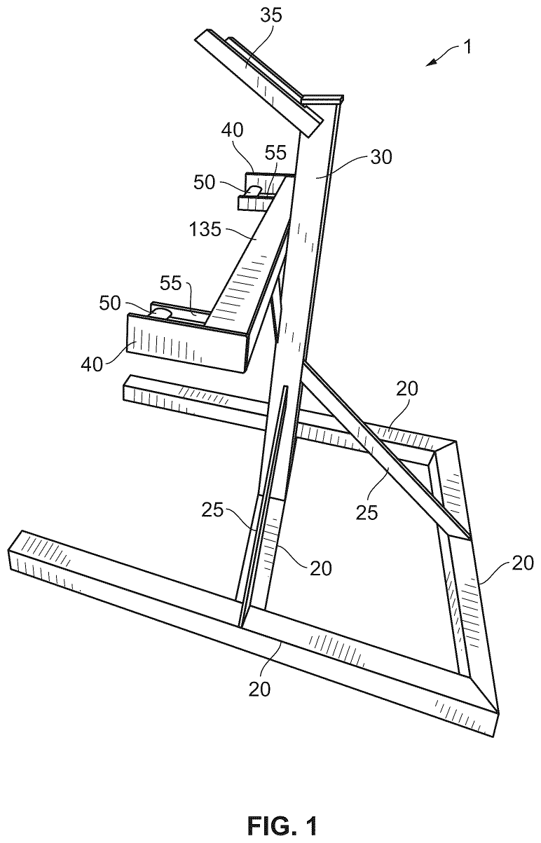

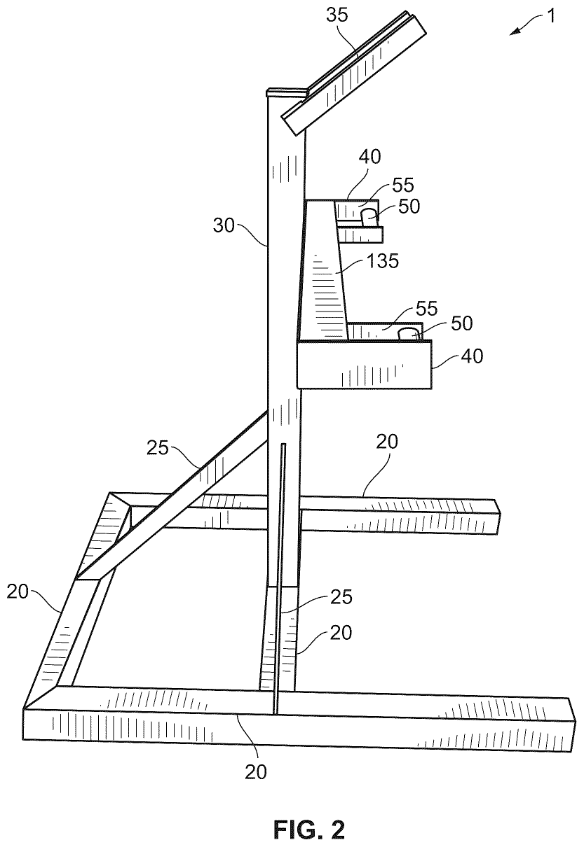

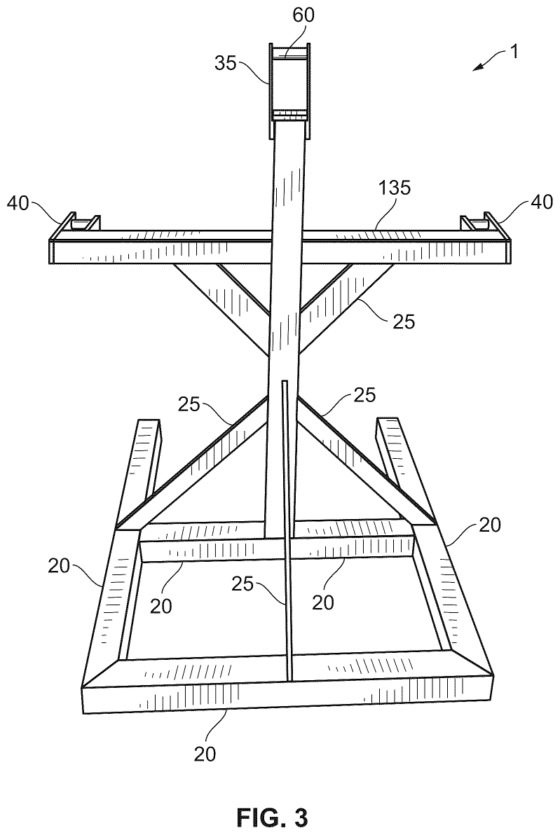

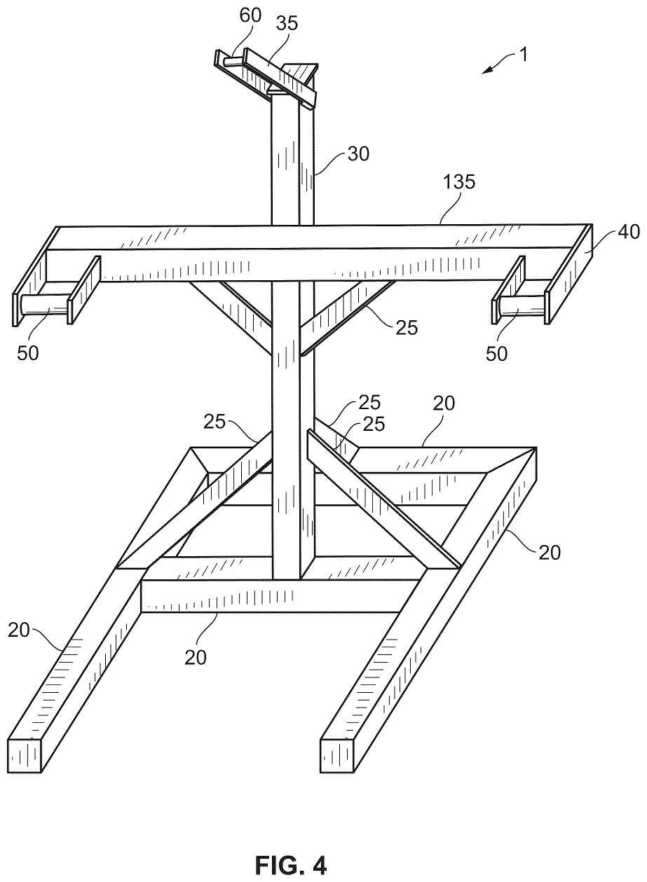

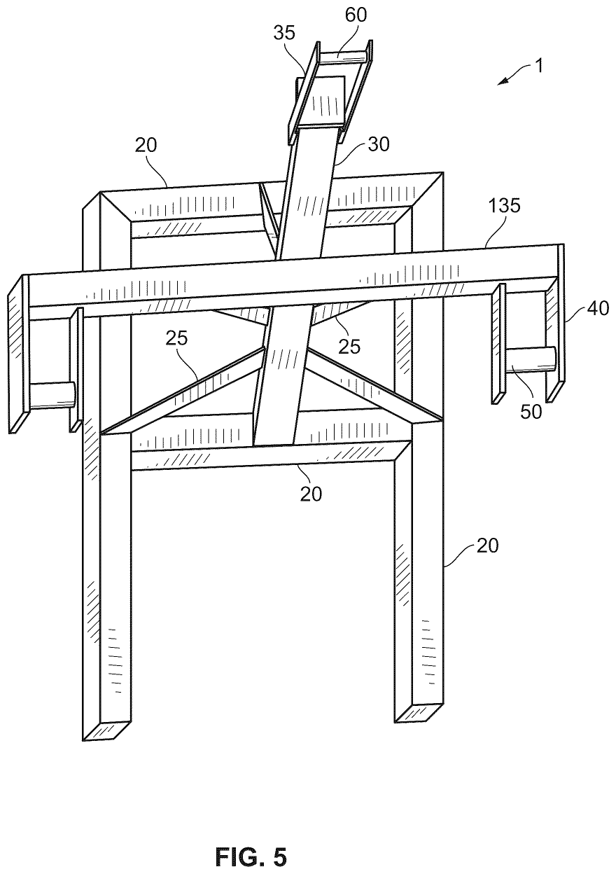

With reference to FIGS. 1-5 initially, the stand 1 consists of a frame assembly 15, designed to securely support a quick hitch 5 in a manner that mimics its attachment to an implement. The stand 1 provides proper alignment and stability to ensure safe handling and efficient operation.

The frame assembly 15 comprises a base frame 20 that is generally rectangular in shape, but not limited to such, and is constructed from high-strength steel tubing. The base frame 20 provides a low center of gravity to prevent tipping and serves as the foundational structure of the stand 1, distributing weight evenly to support heavy quick hitches 5. A plurality of diagonal reinforcement members 25 extend between a central vertical support 30 and the base frame 20, increasing structural rigidity and minimizing lateral movement or tipping under load.

The central vertical support 30 extends upward from the base frame 20 and functions as the primary vertical structural element for supporting the quick hitch 5. The central vertical support 30 includes one or more mounting points for structural components, including a lower hitch support crossbar 135 and an upper hitch retention bracket 35. The upper hitch retention bracket 35 is mounted toward the upper end of the central vertical support 30 and is configured to receive and secure an upper hitch connection point 105 or top hitch connection point 60 of the quick hitch 5, thereby stabilizing the hitch in an upright orientation.

The lower hitch support crossbar 135 is fixed horizontally to the central vertical support 30 and extends laterally across the stand 1. A pair of lower hitch support arms 40 is attached to opposing ends of the lower hitch support crossbar 135, with each arm configured to receive and engage a corresponding lower hitch connection point 45 of the quick hitch 5. Each lower hitch support arm 40 includes a recessed receiving bracket 50 to guide the lower hitch connection point 45 into proper seating position. A set of lateral positioning stops 55 is positioned adjacent to or integrated with the recessed receiving brackets 50 to prevent side-to-side displacement of the quick hitch 5 once seated, ensuring secure alignment during storage or servicing.

Positioned above the lower hitch support arms 40, the upper hitch retention bracket 35 is strategically placed to capture a top hitch connection point 60 of the quick hitch 5. This upper hitch retention bracket 35 simulates the standard implement attachment process, providing a secure upper connection that prevents forward tilting or unintended disengagement. The combination of lower hitch support arms 40 and the upper hitch retention bracket 35 creates a fully stabilized docking system for the quick hitch 5.

### Mobility & Adjustability Features

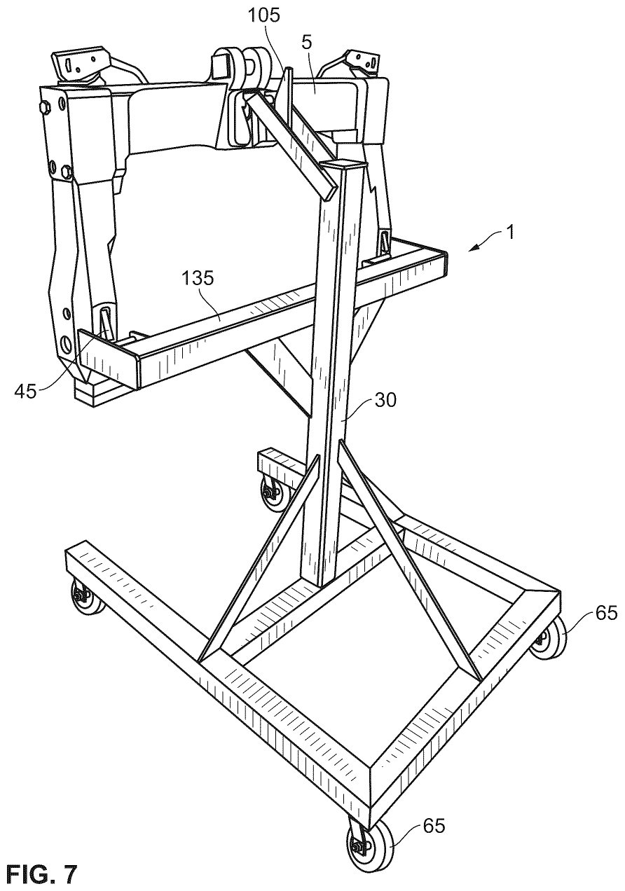

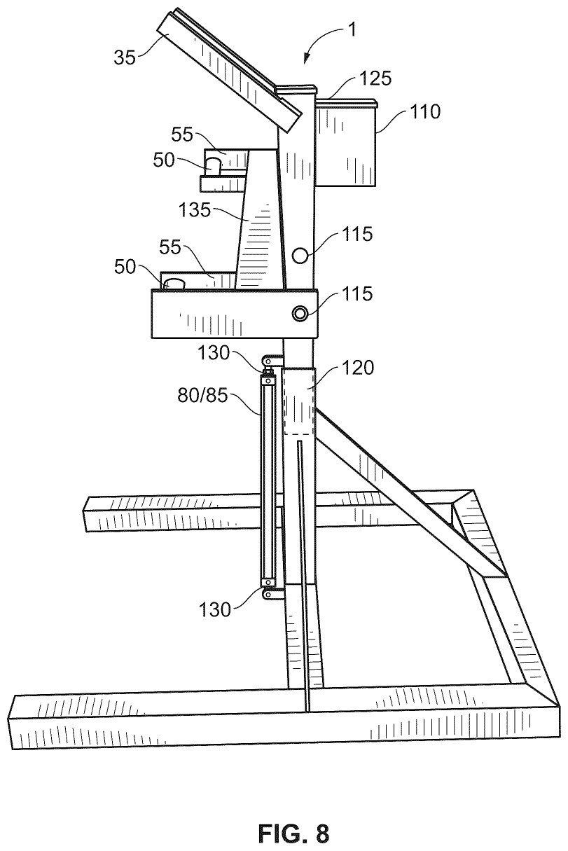

Referring to FIGS. 7-8, for enhanced usability, the stand 1 may include optional mobility and height-adjustment features.

In one embodiment, the stand 1 is equipped with a plurality of heavy duty caster assemblies 65, which allow for easy transport without requiring a tractor or additional lifting equipment. The heavy-duty caster assemblies 65 are mounted near each corner of the base frame 20, ensuring even weight distribution and stability during movement.

The stand 1 may be configured with different types of heavy duty caster assemblies 65 based on the environment. One embodiment features pneumatic foam-filled caster assemblies 70, providing smooth mobility over uneven outdoor terrain, such as grass, gravel, and dirt surfaces. Alternatively, a version equipped with polyurethane shop caster assemblies 75 is optimized for hard surfaces, such as concrete and tile shop floors, reducing rolling resistance and increasing maneuverability. The pneumatic foam-filled caster assemblies 70 version may also be used in both indoor and outdoor applications, providing versatility for a range of work environments.

For users who do not require mobility, the stand 1 may be configured in a semi-fixed-position embodiment, without heavy duty caster assemblies 65 of any type. This stationary version provides a stable, non-mobile storage solution for the quick hitch. The movement of the stand 1 requires the user to drag by hand to position or move the stand 1.

With specific reference to FIG. 8, an alternative embodiment of the stand 1 incorporates a pneumatic height adjustment mechanism 80 or hydraulic height adjustment mechanism 85 within the central vertical support 30 in the form of a telescoping system 90. This telescoping system 90 allows the operator to raise or lower the quick hitch 5 engagement points, ensuring precise height alignment during attachment or detachment. The pneumatic height adjustment mechanism 80 or hydraulic height adjustment mechanism 85 may be manually controlled via a locking pin 95 or automated using an air cylinder 100, allowing for incremental height adjustment.

In some embodiments, the telescoping system includes a series of vertically spaced receptacles 115 formed along a telescoping member 120 of the telescoping system 90. Each vertically spaced receptacle 115 is configured to receive a manually insertable locking pin, allowing the operator to fix the hitch support assembly at one of several discrete height positions. The vertically spaced receptacles 115 may be uniformly or non-uniformly spaced to accommodate a range of vertical alignment positions based on the height of the quick hitch 5 or tractor 10 configuration.

In the pneumatic embodiment, the air cylinder 100 may be implemented as a tie rod air cylinder such as the one, for example only, from McMaster-Carr that is a double acting, 3″ bore size, 3-3/8″ wide, 19″ stroke length. This is a type of pneumatic actuator that uses compressed air to generate linear motion. It consists of a cylindrical body with a piston inside, and tie rods running along the outside to hold the end caps securely in place. When paired with a clevis bracket 130 with pin such as the one, for example, from McMaster-Carr that is for the above described 3″ bore size tie rod air cylinder, the air cylinder 100 can be securely mounted to a telescoping version of the central vertical support 30, allowing controlled pivoting and movement during operation. The clevis bracket 130 attaches to both or either end of the air cylinder 100, and a pin (not shown) secures the connection while permitting precise height adjustments. This configuration ensures smooth and reliable positioning of the quick hitch 5 engagement points, particularly in repair shop environments where manual alignment is necessary due to hydraulic malfunctions in tractors.

In some embodiments, the stand 1 may further include a tool box 110 mounted to the central vertical support 30 or to the base frame 20. In one embodiment incorporating the pneumatic tie rod air cylinder 100, the tool box 110 is positioned near the top of the central vertical support 30 and configured to store small implements, pins, wrenches, or alignment tools used during quick hitch 5 mounting or servicing. While shown in the Figures near the top of the central vertical support 30, it is contemplated that the tool box 110 may be mounted at any location along the central vertical support 30 or elsewhere on the stand 1, including the base frame 20. The tool box 110 may include a hinged or latched lid 125 and be formed of metal or high-strength polymer. The tool box 110 may be included in any embodiment of the stand 1 as with the optional caster assemblies, without departing from the spirit of the invention.

### Operation and Use

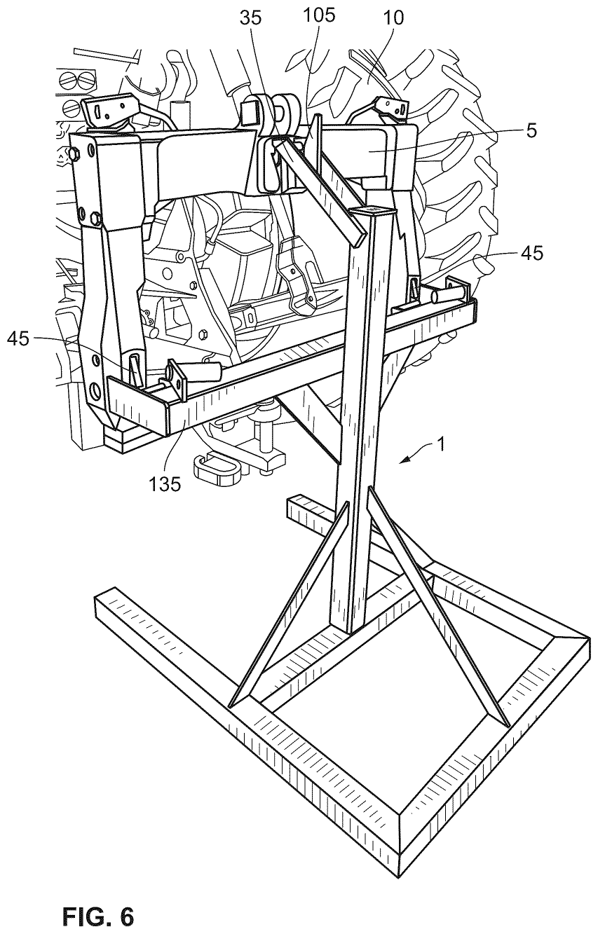

Referring to FIGS. 6-7, the stand 1 provides an efficient and user-friendly method for handling quick hitches 5, eliminating common hazards associated with improper lifting and storage. To dismount a quick hitch 5 onto the stand 1, the operator positions the tractor 10 directly in front of the stand 1, ensuring proper alignment. The quick hitch 5 is slowly lowered so that the lower hitch connection points 45 rest securely in the recessed receiving brackets 50 of the lower hitch support arms 40 of the stand 1. An upper hitch connection point 105 engages with the upper hitch retention bracket 35, securing the quick hitch 5 in an upright position. Once the quick hitch 5 is fully seated, the tractor 10 can detach and drive away, leaving the quick hitch 5 safely positioned on the stand 1.

To reattach a quick hitch 5 to the tractor 10, the tractor 10 is backed up to the stand 1, aligning the quick hitch 5 with the tractor's 10 three-point hitch system. The upper hitch connection point 105 disengages from the stand's 1 upper hitch retention bracket 35 as the quick hitch 5 is lifted. The operator lifts the quick hitch 5 using the tractor's 10 hitch mechanism, freeing it from the lower hitch support arms 40, then drives away with the quick hitch 5 securely attached. If height adjustment is needed, the telescoping pneumatic height adjustment mechanism 80 comprising the air cylinder 100 (as described above) or the hydraulic height adjustment mechanism 85 (as desired) within the central vertical support is engaged to raise or lower the hitch support assembly 110. The operator can then proceed with standard mounting or dismounting procedures.

### Category Iv Quick Hitch Embodiment

In addition to Category 1-3 compatibility, the stand 1 may be configured for Category IV quick hitches 5, which are larger and heavier than standard hitches 5. This embodiment includes reinforced frame assembly 15, such as thicker steel tubing, additional bracing, and an increased weight capacity, to accommodate greater loads and forces. The frame assembly 15 and central vertical support 30 are widened and strengthened, ensuring secure docking for larger quick hitches 5. Refinements for this embodiment will be based on specific Category IV hitch dimensions and load requirements.

### Advantages of the Quick Hitch Safety Stand

Proper use of the stand 1 prevents injuries such as back strain, crushed fingers, and foot injuries associated with lifting and balancing a quick hitch 5 manually. It provides a stable and upright storage solution, reducing the risk of tipping or falling. The stand 1 significantly reduces the time required to attach or detach a quick hitch 5, while eliminating the need for additional lifting equipment or personnel assistance.

Additionally, the mechanic stand 1 version eliminates the challenge of dismounting a quick hitch from a disabled tractor 10, providing adjustable height alignment for seamless removal. The invention also prevents damage to tractors 10, hydraulic hoses, and nearby equipment caused by improper handling or falling quick hitches 5.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure and that they may make various changes, substitutions, and alterations without departing from the spirit and scope of the disclosure. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded.

1. A stand for supporting a tractor quick hitch, comprising:
a base frame;
a central vertical support extending upward from the base frame;
at least one lower hitch support arm mounted to the central vertical support and configured to receive a lower hitch connection point of the quick hitch; and
an upper hitch retention bracket coupled to the central vertical support and configured to receive an upper hitch connection point of the quick hitch,
wherein the lower hitch support arm and the upper hitch retention bracket are positioned to hold the quick hitch in a stable, upright configuration when the quick hitch is placed on the stand.

2. The stand of claim 1, wherein the base frame is formed of high-strength steel tubing and defines a generally rectangular perimeter.

3. The stand of claim 1, further comprising a plurality of diagonal reinforcement members extending between the central vertical support and the base frame.

4. The stand of claim 1, wherein the lower hitch support arm comprises a recessed receiving bracket configured to guide the lower hitch connection point into position.

5. The stand of claim 1, wherein the upper hitch retention bracket is positioned vertically above the lower hitch support arm to simulate an implement attachment geometry.

6. The stand of claim 1, further comprising lateral positioning stops configured to limit side-to-side movement of the quick hitch when seated on the stand.

7. The stand of claim 1, further comprising:
a telescoping system housed within the central vertical support and configured to adjust a height of the upper hitch retention bracket relative to the base frame;
a height adjustment mechanism operatively coupled to the telescoping system; and
a manual or automated control component operable to selectively raise or lower the quick hitch engagement points.

8. The stand of claim 7, wherein the height adjustment mechanism is a pneumatic cylinder operably connected to the telescoping system.

9. The stand of claim 7, wherein the height adjustment mechanism is a hydraulic cylinder.

10. The stand of claim 7, wherein the control component comprises a manually insertable locking pin configured to fix the telescoping system at selected positions.

11. The stand of claim 10, wherein the telescoping system comprises a series of vertically spaced receptacles configured to receive the locking pin for setting the height of the upper hitch retention bracket.

12. The stand of claim 7, further comprising a hitch support assembly coupled to a movable portion of the telescoping system and comprising the upper hitch retention bracket.

13. The stand of claim 7, further comprising a plurality of heavy-duty caster assemblies coupled to the base frame and configured to allow movement of the stand across a support surface.

14. The stand of claim 13, wherein the caster assemblies comprise pneumatic foam-filled wheels for outdoor surfaces.

15. The stand of claim 13, wherein the caster assemblies comprise polyurethane wheels optimized for indoor shop floors.

16. A quick hitch support stand comprising:
a base frame;
a central vertical support extending from the base frame;
a telescoping system housed within the central vertical support;
a tie rod air cylinder operatively connected to the telescoping system and configured to raise or lower a hitch support assembly; and
a clevis bracket with a pin securing the tie rod air cylinder to the stand, the clevis bracket permitting controlled pivoting of the tie rod air cylinder during operation.

17. The stand of claim 16, wherein the tie rod air cylinder is a double-acting cylinder having a bore size of approximately 3 inches and a stroke length of at least 19 inches.

18. The stand of claim 16, wherein the clevis bracket is coupled to a rod end of the air cylinder and is removably mounted to allow replacement of the air cylinder.

19. The stand of claim 16, wherein the air cylinder is actuated by a pneumatic control interface mounted on an exterior surface of the stand.

20. A stand for supporting a Category IV tractor quick hitch, comprising:
a reinforced frame assembly including a base frame constructed from heavy-gauge steel tubing;
a widened central vertical support extending from the base frame;
a reinforced upper hitch retention bracket mounted to the widened central vertical support; and
at least one reinforced lower hitch support arm configured to receive lower hitch connection points of the Category IV quick hitch,
wherein the reinforced frame assembly is dimensioned and constructed to support increased weight and loads of Category IV quick hitches.

21. The stand of claim 20, wherein the reinforced frame assembly further comprises additional cross bracing and gusset plates to enhance load distribution and resistance to lateral deformation.

22. A method of mounting and dismounting a tractor quick hitch using a quick hitch support stand, the method comprising:
positioning the quick hitch support stand in alignment with a tractor three-point hitch;
lowering a quick hitch from the tractor such that a plurality of lower hitch connection points of the quick hitch seat within recessed receiving brackets of lower hitch support arms on the support stand;
engaging an upper hitch connection point of the quick hitch with an upper hitch retention bracket on the support stand to secure the quick hitch in an upright position;
detaching the quick hitch from the tractor while the quick hitch remains supported in the upright position on the support stand; and
repositioning the quick hitch onto the tractor by reversing the foregoing steps,
wherein the method further comprises adjusting a telescoping central vertical support of the support stand to raise or lower a hitch support assembly before at least one of the mounting or dismounting steps.
